(19) United States
(12) Patent Application Publication
(10) Pub. No.: US 2004/0201613 A1
(43) Pub. Date: Oct. 14, 2004

(54) Methods and systems for arranging content for printing in a distributed environment

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/941,065

(22) Filed: Aug. 27, 2001

(51) Int. Cl. G06F 15/00

(52) U.S. Cl. 345/738; 709/203; 715/517

(57) ABSTRACT

Methods and systems for arranging content for printing in a distributed environment are described. In one embodiment, users can maintain images or graphics in a personal imaging repository. The images or graphics can include compositions that comprise multiple images and/or graphics. An imaging service enables a user to access the images or graphics in their personal imaging repository to arrange the images or graphics on a representation of a page that is to be printed. A resultant page representation can be saved in the user's personal imaging repository or printed on one or more user-selectable printers.

### TECHNICAL FIELD

This invention relates to printing and distributed environments, and more particularly concerns methods and systems for arranging content for printing in a distributed environment.

### BACKGROUND

As computer technology has advanced, the role of computers in our daily lives has expanded, as has the need for various peripheral or supporting devices. One typical peripheral device used with computers is a printer, which generates a hard copy of data that is used by the computer. The types and capabilities of printers available has similarly been expanding, resulting in a wide variety of printers with a range of printing capabilities, performance, and price.

One significant expansion in the use of computer technology is the networking of computers together. Networking computers together allows the computers to communicate with one another as well as with other devices, such as printers. As computer networks, such as the Internet, continue to develop, there is an increasing demand for additional and improved functionalities that draw upon and exploit the full computing potential of computer networks.

Accordingly, this invention arose out of concerns associated with providing improved methods and systems for arranging content for printing in a distributed environment.

### SUMMARY

Methods and systems for arranging content for printing in a distributed environment are described.

In one embodiment, users can maintain images or graphics in a personal imaging repository. The images or graphics can include compositions that comprise multiple images and/or graphics. An imaging service enables a user to access the images or graphics in their personal imaging repository to arrange the images or graphics on a representation of a page that is to be printed. A resultant page representation can be saved in the user's personal imaging repository or printed on one or more user-selectable printers.

### BRIEF DESCRIPTION OF THE DRAWINGS

FIG. 1 illustrates an exemplary distributed system in which pre-defined print option configurations can be used.

FIG. 2 illustrates an exemplary distributed system illustrating the use of pre-defined print option configurations in a distributed environment in additional detail.

FIG. 3 illustrates an exemplary Web-based architecture in which pre-defined printer configurations can be used.

FIG. 4 illustrates an exemplary user interface presented by a Web browser.

FIG. 5 illustrates an exemplary document assembly user interface presented by a Web browser.

FIG. 6 illustrates an exemplary document assembly user interface presented by a Web browser.

FIG. 7 illustrates an exemplary document assembly user interface presented by a Web browser.

FIG. 8 illustrates an exemplary document assembly user interface presented by a Web browser.

FIG. 9 illustrates an exemplary user interface presented by a Web browser.

FIG. 10 is a block diagram illustrating exemplary software modules in accordance with one embodiment.

FIG. 11 is a flow diagram that illustrates steps in a method in accordance with one embodiment.

FIG. 12 is a flow diagram that illustrates steps in a method in accordance with one embodiment.

FIG. 13 is a block diagram that illustrates one exemplary implementation in accordance with one embodiment.

FIG. 14 illustrates an exemplary computer system in additional detail.

### DETAILED DESCRIPTION

Overview

Methods and systems for arranging content for printing in a distributed environment are described. In one embodiment, users can maintain imaging data, e.g. images or graphics in a personal imaging repository. The imaging data can include compositions that comprise multiple documents or pages of imaging data. A network- or Web-based imaging service enables a user to access the imaging data in their personal imaging repository, and to arrange and manipulate the imaging data on a representation of a page that is to be printed. A resultant page representation, termed a “composition document”, can be saved in the user's personal imaging repository or printed on one or more user-selectable printers.

Exemplary Distributed System

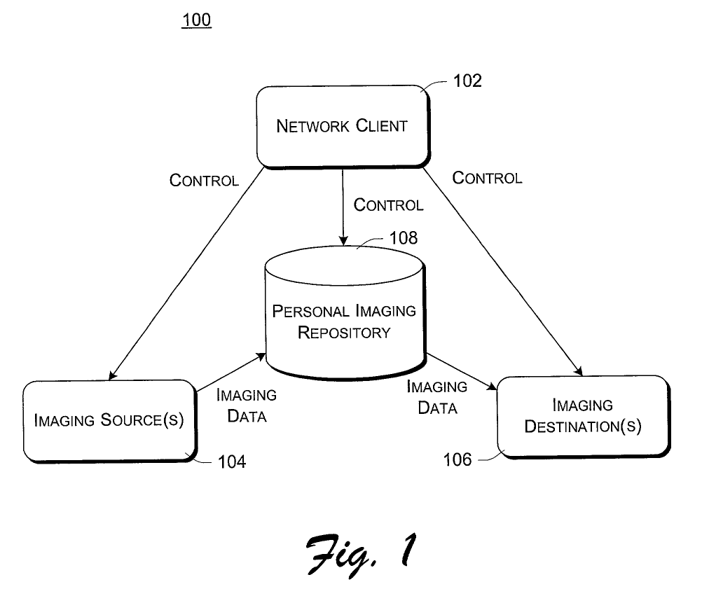

FIG. 1 illustrates an exemplary distributed system 100 in which various embodiments described below can be implemented. In system 100, a network client device 102 is in communication with one or more imaging sources 104, one or more imaging destinations 106, and a personal imaging repository 108. A user of client device 102 can communicate with imaging source(s) 104 to select or identify images to be stored in personal imaging repository 108. Imaging sources 104 represent any of a wide variety of devices that are capable of providing images to other devices. Examples of imaging sources 104 can include computers, cameras (e.g., digital still or video cameras), scanners, applications, Web sites, and so forth.

Repository 108 represents image storage facilities personalized to the individual user, although alternatively multiple users may have access to the same repository 108. Repository 108 is maintained on one or more computers, such as network client 102, an imaging source(s) 104, an imaging destination(s) 106, another computer (not shown), or combinations thereof. The imaging data in repository 108 can be any type of printable data, such as text, drawings, frames of video or animations, pictures, combinations thereof, and so forth.

The user, via network client 102, can select images from imaging repository 108 to be communicated to imaging destination(s) 106 for printing. In one aspect, the selected images from the repository can be communicated to the imaging destination in accordance with pre-defined print option configurations identified by the user, and as described in co-pending patent application Ser. No. ______, entitled “Pre-defined Print Option Configurations for Printing in a Distributed Environment”, naming Shell Simpson, Ward Foster, and Kris Livingston as inventors, bearing Attorney Docket No. 10008181, the disclosure of which is incorporated by reference.

Imaging destination 106 represents any of a wide variety of devices that are capable of processing images in some manner. Examples of imaging destinations 106 include printers, plotters, services managing printing devices, and so on.

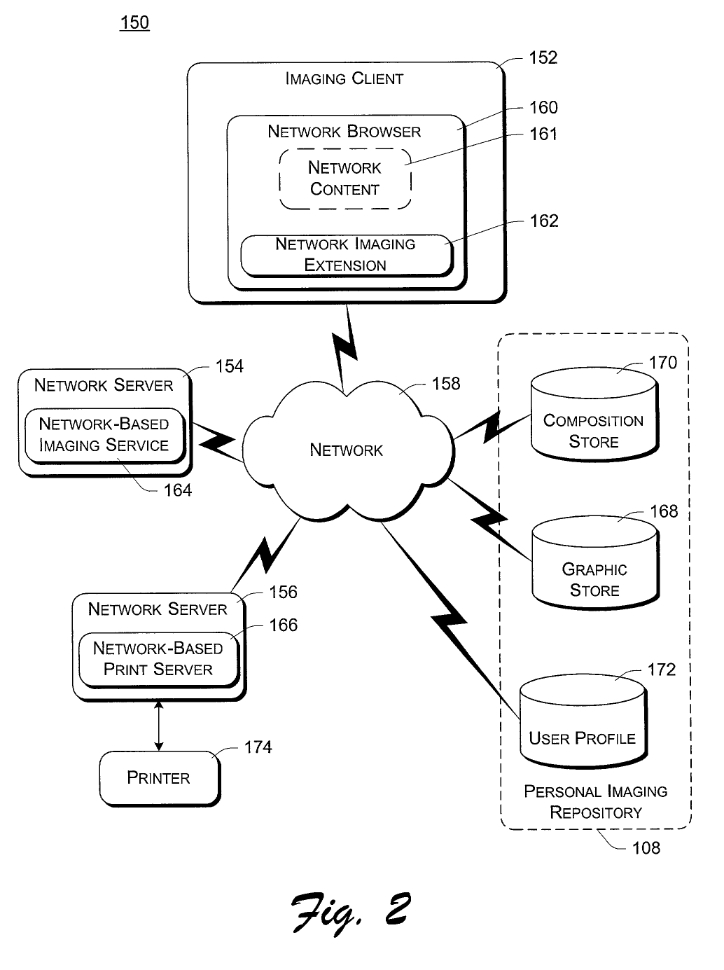

FIG. 2 shows an exemplary distributed system 150 in a distributed environment in additional detail. System 150 includes an imaging client 152 coupled to multiple network servers 154 and 156 via a network 158. Client 152 and servers 154 and 156 represent any of a wide variety of conventional wired and/or wireless computing devices, such as desktop computers, portable computers, dedicated server computers, multi-processor computing devices, cellular telephones, personal digital assistants (PDAs), handheld or pen-based computers, gaming consoles, and so forth.

Network 158 represents one or more conventional data distribution networks that can be used to communicate data and other information (e.g., control information) between or among various computing devices. Examples of network 158 include the Internet, a local area network (LAN), a public or private wide area network (WAN), combinations thereof, and so on. Network 158 can include multiple different types of networks, including wired and/or wireless portions, employing any of a wide variety of different communications protocols, including public and/or proprietary communications protocols.

During operation, a network browser 160 executing on imaging client 152 allows a user of client 152 to interact with network servers 154 and 156, as well as network services executing on such servers. Network browser 160 includes a network imaging extension 162 that allows network content 161 executing in browser 160 to communicate with the user's personal imaging repository 108, which may include communication with services via network 158. As used herein, services refer to software components that can execute on one or more computing devices and are accessible to provide functionality to imaging client 152, such as imaging sources, imaging destinations, printer configuration components, and so forth. Network imaging extension 162 can be implemented in any of a wide variety of manners, such as an application programming interface (API) providing methods that can be called by content 161 and used to interact with servers 154 and 156 (e.g., to load, save, modify, delete, etc. documents).

Network server 154 executes a network-based imaging service 164 that allows a user of browser 160 to interact with his or her personal imaging repository (e.g., add, remove, and/or modify graphics in the repository) and identify an image for printing. Images identified or selected for including in the user's personal imaging repository can be indicated by value (e.g., the actual image data) or by reference (e.g., a pointer to or identifier of the image stored elsewhere). The image to be printed can be made up of graphics from one or more different graphic sources, and include any type of printable data (e.g., text, graphics, and so forth).

Network-based imaging service 164 represents one or more services accessible to imaging client 152. Each service can execute on the same server or alternatively on multiple different servers. These different services can provide different functionality (e.g., one service may be responsible for graphic storage and retrieval functionality, while another service is responsible for merge functionality allowing graphics to be merged together). Additionally, some services may be fully or partially overlapping in functionality provided by other services, allowing a degree of fault-tolerance to be built into system 150 (e.g., one service can take over the responsibilities of another if the other fails).

The graphic for an image is received from a graphic store 168 and/or a composition store 170. Graphic store 168 stores individual graphics (also referred to as documents or more generally data capable of being represented as a two dimensional graphic), such as individual files. These individual graphics in store 168 can be used as individual printable images via imaging service 164. Each individual graphic can be any of one or more types of printable data (e.g., text, pictures, etc.), and may result in multiple hard copy pages when printed. Additionally, a user of browser 160 may identify multiple individual graphics from graphic store 168 that are to be compiled together as a single image for printing. In this situation, network-based imaging service 164 provides an interface that allows the user of browser 160 to select different individual images and store the compilation of individual images as a single composition document (also referred to as a composition image) in composition store 170. The composition document may include the actual data from the individual images, or alternatively identifiers (e.g., file name and path, or Uniform Resource Locators (URLs)) of where the individual images can be retrieved for printing or displaying to the user.

Graphic store 168 and composition store 170 are illustrated in system 150 as two separate stores. Alternatively, multiple such stores may exist in system 150, and one or more graphic stores may be combined with one or more composition stores. Additionally, one or more of these stores 168 or 170 may be implemented on one of servers 154 or 156, and/or imaging client 152.

Network-based imaging service 164 also provides an interface via which a user of browser 160 can access imaging data in the form of documents, pages of documents, and portions thereof, and manipulate and arrange them into a composition document or page.

In order to print an image, the user identifies the image (optionally selecting graphics that are to be part of the image). A print request, including the image data is then communicated to network-based print server 166 executing on network server 156. Upon receipt of the print request, network-based printer server 166 interacts with a printer 174 coupled thereto to produce a hard copy of the image in accordance with the received image data.

Exemplary Web-Based Architecture

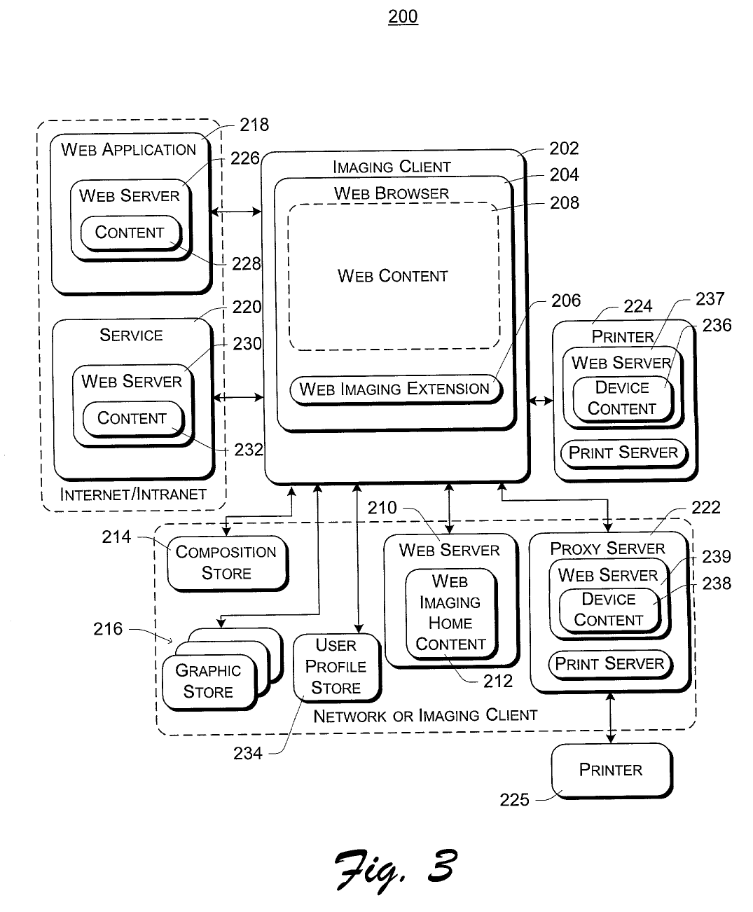

FIG. 3 illustrates an exemplary Web-based architecture 200 That is suitable for use in implementing the various described embodiments. Web-based architecture 200 refers to the World Wide Web (or simply the Web), which is a distributed collection of interlinked, user-viewable documents (typically referred to as Web documents or Web pages) that are accessible via the Internet. The Web also refers to the client and server components which provide user access to such documents using standardized Internet protocols. Currently, the primary standard protocol for allowing applications to locate and acquire Web documents is the HyperText Transport Protocol (HTTP), and the Web pages are encoded using a standard markup language such as the HyperText Markup Language (HTML) or eXtensible Markup Language (XML). Alternatively, other protocols or languages may be used.

In architecture 200, an imaging client 202 (i.e., similar to imaging client 152 of FIG. 2) includes a Web browser 204 including a web imaging extension 206. Browser 204 is able to load and execute web content 208 (e.g., Java scripts or programs) from various sources. In the illustrated example, Web browser 204 establishes a communication channel or connection with Web server 210, causing Web imaging home content 212 to be copied to imaging client 202 as at least part of Web content 208. Although illustrated as being copied from Web server 210, it is to be appreciated that Web imaging home content 212 could alternatively be loaded from a local or intermediary source, such as a cache (not shown) implemented on imaging client 202. Additionally, any inputs by the user to Web content 208 are typically handled by Web content 208 rather than being returned to Web imaging home content 212.

Once loaded in Web browser 204, Web content 208 can communicate, via Web imaging extension 206, with other components in architecture 200, allowing access to a personal imaging repository as well as imaging sources and imaging destinations. In the illustrated example, the personal imaging repository includes composition store 214 and graphic store 216, the imaging sources include Web application 218 and service 220, and the imaging destinations include proxy server 222 and printer 224.

Web application 218 includes a Web server 226 that maintains (or obtains/creates) content 228 accessible to Web content 208. Similarly, service 220 maintains a Web server 230 that maintains (or obtains/creates) content 232 accessible to Web content 208. The content 228 and 232, when generated (e.g., from a file or dynamically) and executed on imaging client 202 (e.g., as part of Web content 208), can make various functionality available to Web content 208, such as image sources, combine multiple graphics into a composition document, manipulate imaging data such as logical pages, graphics and text, as will become more apparent below.

Printer 224 and proxy server 222 each optionally include a print server for queuing and managing received print requests, and a Web server 237 and 239 storing or dynamically generating device content 236 and 238, respectively. Device content 236 represents content (which may be generated dynamically) that is provided to the Web browser 204 by the Web server 237. Device content 236 is a Web service available to imaging client 202 that represents printer 224 and that can access the user's personal imaging repository. The device content 236, when downloaded and executed on client 202 (e.g., as part of Web content 208), can access the stores 214 and 216 via Web imaging extension 206 to obtain graphics and upload the graphics to printer 224 for printing. The upload to printer 224 is accomplished using existing conventional mechanisms (e.g., HTTP POSTs or TCP/IP socket connections) that allow content executing within the browser to communicate with the server from which that content came. In the illustrated example, imaging extension 206 is only used to obtain graphics from the personal imaging repository, not to upload the graphics to the printer.

Proxy server 222 allows a printer(s) that does not host a Web server to be represented by a Web service. Proxy server 222 includes device content 238 and Web server 239, which operate analogous to device content 236 and Web server 237, respectively. The printer 225 is represented by device content 238 and graphics obtained by the device content 238 (presented in the context of the device). This device content, when downloaded and executed on client 202 (e.g., as part of Web content 208), can upload graphics accessed through the imaging extension to proxy server 222, which in turn forwards these graphics to printer 225.

Web application 218 and service 220 may each be accessible by imaging client 202 via the Internet or via a local network (e.g., an Intranet). Each of the stores 214 and 216, as well as user profile store 234, Web server 210, and proxy server 222, may be accessible via a network (e.g., an Intranet or the Internet) and/or located on imaging client 202.

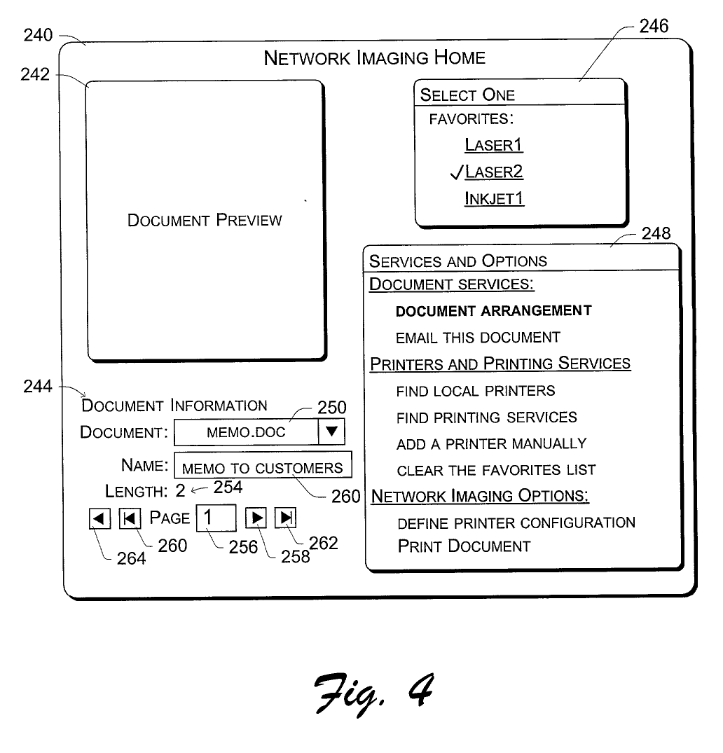

During operation, Web content 208 generates and renders, via Web browser 204, one or more user interfaces (e.g., graphical user interfaces (GUIs)) that allows the user to interact with his or her personal imaging repository. This interaction includes allowing the user to select images or documents for printing, to identify pre-defined printer configurations to be used in printing selected documents, to select imaging data and manipulate or otherwise arrange the imaging data for printing. Example user interfaces rendered by Web content 208 are discussed below with reference to FIGS. 4-9. The various interfaces can be separate Web pages, or alternatively portions of another (or the same) Web page.

Exemplary UIs

FIG. 4 illustrates an exemplary user interface presented by Web browser 204 of FIG. 3. In the illustrated example, user interface 240 is displayed by Web browser 204 as a result of loading the Web imaging home content 212. User interface 240 includes a document preview window 242, a document information portion 244, a favorite printers portion 246, and a services and options portion 248. User interface 240 allows the user to select one or more documents for printing via document information portion 244. The user can select the desired document by name via a pull down menu input 250 or change the name of the selected document in name field 260. Alternatively, other document-selection input mechanisms may be supported, such as cutting and pasting of the document name, dragging and dropping an icon representing the document, supporting a “browse” feature allowing the user to search his or her personal imaging repository (or elsewhere) for documents, and so forth.

The length of the user-selected document (e.g., in pages) is illustrated in a length field 254. Document preview window 242 provides a location via which a small preview image of the document selected for printing (or other processing) is displayed to the user. The document preview window 242 can also be used to arbitrarily arrange or otherwise manipulate imaging data, as will be described in more detail below. A current page section 256 identifies the current page(s) being displayed in document preview window 242, and page manipulation buttons 258, 260, 262, and 264 allow the user to easily advance to the next page in the document, the previous page in the document, the last page of the document, or the first page of the document, respectively.

Favorite printers portion 246 identifies one or more printers that are selectable by the user for printing, and can include, for example, the user's preferred printers, suggested printers to be used by the user, default printers, and so forth. In the illustrated example, each printer identified in favorites portion 246 is identified by a hyperlink (illustrated as being underlined). The user can select one of the printers that the identified document is to be printed on by activating the hyperlink (e.g., by using a pointer control device to situate a pointer over the hyperlink on screen and click a button of the control device).

Services and options portion 248 allows the user to identify or request options or services, such as to add a printer to favorites portion 246, clear favorites portion 246, print the document, and so forth.

One of the services available for selection on the services and options portion 248 is a “document arrangement” portion. In this embodiment, a user can select this option so that they can arrange or otherwise manipulate imaging data for printing. The functionality that can be provided by selecting this option can comprise any functionality that can be utilized to manipulate or otherwise arrange imaging data on a page for printing. Such manipulations and arrangements can include, without limitation, scaling, rotating, translating, and/or providing multiple different individual pages or documents on a single page for printing. The multiple different pages can comprise multiple different pages from a single common composition document, or multiple different pages from multiple different composition documents.

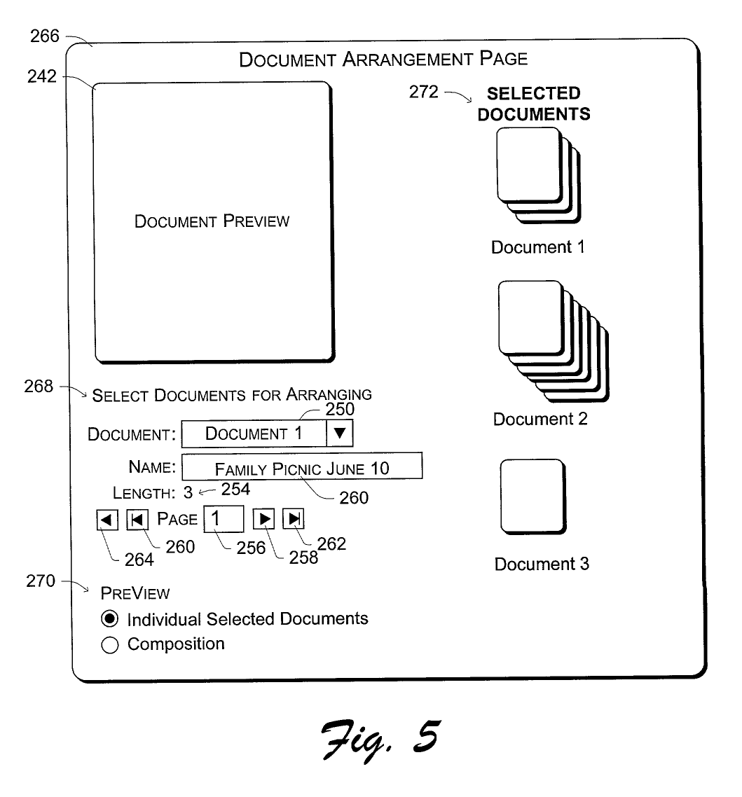

FIG. 5 shows an exemplary user interface 266 that is presented by Web browser 204 of FIG. 3 responsive to a user selecting the “document arrangement” service. In the illustrated example, user interface 266 (entitled “Document Arrangement Page”) is displayed by Web browser 204 as a result of loading the Web imaging home content 212 and selecting the link to the Document Arrangement service. As in the above user interface, user interface 266 includes a document preview window 242. In addition, a document arrangement portion 268, a preview portion 270 and a selected documents portion 272 is provided. User interface 266 allows the user to select one or more documents, and then manipulate or otherwise arrange those documents in any number of ways. The user can select desired documents by name via a pull down menu input 250, or change the name of the selected document in the name field 260. Alternately, other document selection input mechanisms can be supported such as cutting and pasting of the document name, dragging and dropping an icon representing the document, supporting a “browse” feature that allows the user to search his or her personal imaging repository (or elsewhere) for documents, and so forth.

The length of the user-selected documents (e.g., in pages) is illustrated in a length field 254. Document preview window 242 provides a location via which a small preview image of the document selected for printing (or other processing) is displayed to the user. The document preview window 242 can also be used to arbitrarily arrange or otherwise manipulate imaging data. A current page section 256 identifies the current page(s) being displayed in document preview window 242, and page manipulation buttons 258, 260, 262, and 264 allow the user to easily advance to the next page in the document, the previous page in the document, the last page of the document, or the first page of the document, respectively.

The selected documents portion 272 can provide an iconic representation of the documents that have been selected by the user. In this particular example, the user has selected three different documents from their personal imaging repository for use in creating a composition document-i.e., Document 1, Document 2, and Document 3. In this example, Document 1 has three pages, Document 2 has six pages, and Document 3 has one page.

Preview portion 270 can allow the user to toggle the document preview window 242 back and forth between a representation of a physical page that they are creating—termed a “composition document”, and various individual so-called logical documents or pages that have been selected for use by the user.

For example, in this case, the user has indicated, using preview portion 270, that they wish to view “Individual Selected Documents.” Using the document arrangement portion 268, they have additionally indicated that they wish to view page 1 of Document 1. Accordingly, page 1 of Document 1 is displayed for the user. By using the page manipulation buttons 258-264, the user can thus preview Document 1. By changing the document selection in pull down menu input 250, the user can change the document preview between the different documents.

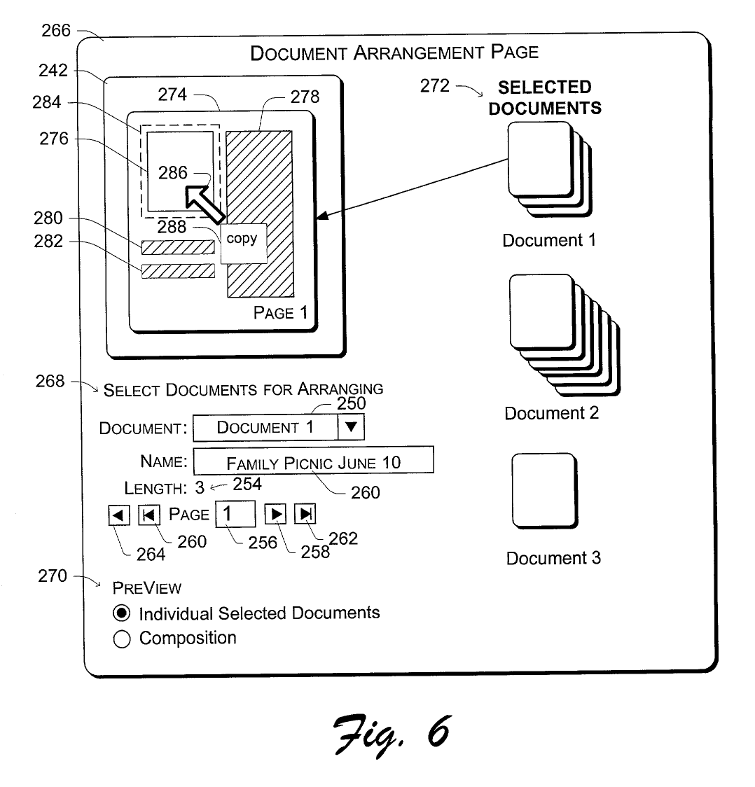

As an example, consider FIG. 6. There, page 1 of Document 1 (designated 274) is displayed in the document preview window 242. By displaying individual pages, the user is able to view the pages so that they can make selections for the composition documents that they are building. Specifically, in this example, the user has identified three different documents from which they desire to incorporate imaging data into a new composition document that they are creating. The user can select from among individual constituent portions of each page, or can select the whole page for incorporation. For example, notice that page 274 includes constituent portions 276, 278, 280, and 282. The constituent portions can comprise any type of imaging data that can be visually perceived by the user such as text, graphics and the like. The user has highlighted constituent portion 276 with a window 284 using a pointer 286 associated with their mouse. A right click drop down menu 288 can be used to copy the selected portion of the page. In the event that the user selects the whole page, the right click drop down menu 288 would be used to select the whole page.

Once the constituent portion or the entire page has been selected by the user, they can then incorporate that portion into their composition document. By selecting the “Composition” selection in preview portion 270, the user can toggle to a preview of their composition document.

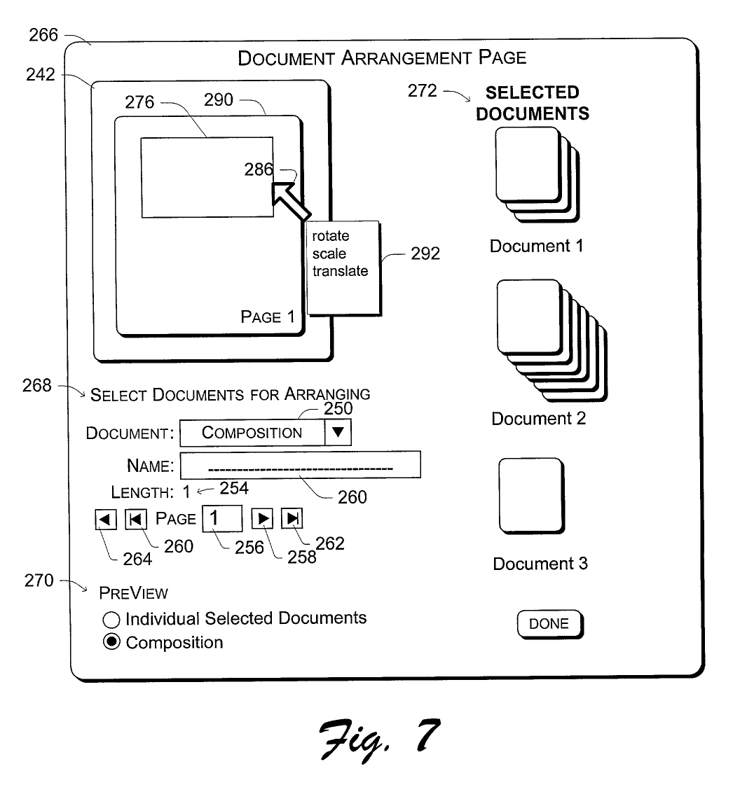

FIG. 7 shows document preview window 242 having been toggled to a preview of the user's composition document. There, a first page of a composition document 290 is displayed in the preview window 242. Notice that a representation of constituent portion 276 has been placed on the composition page 290. In addition to being placed or arranged on the first page of composition 290, the representation has been manipulated by the user in the following way. Specifically, in this example, the constituent portion has been rotated 90-degrees and scaled so that it is slightly larger in width (as viewed in the figure). The manipulation and arrangement functions can be made available to the user in any suitable way such as through the use of a top- or bottom-line menu. In this particular example, such functions are made available for selection via a right click drop down menu 292. That is, after a user has placed the representation of constituent portion 276 on the composition page (e.g., through the use of a similar drop down menu having a “paste” function), they can use the drop down menu 292 (or any other suitable input mechanism) to manipulate or otherwise arrange their selection on the page.

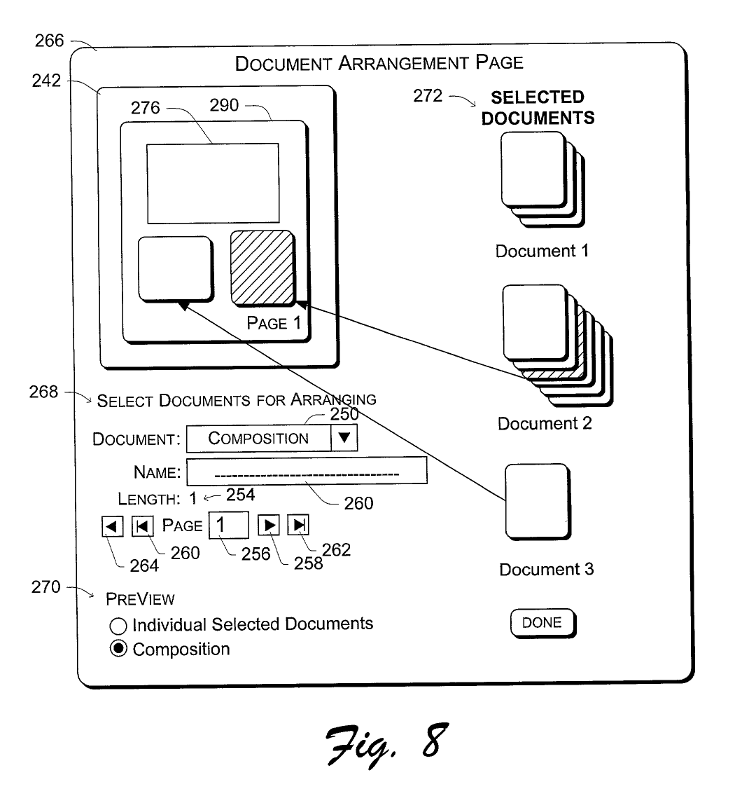

Consider further FIG. 8. There, the user has completed the first page of their composition document by selecting the third page of Document 2 and the only page of Document 3. In addition, the user has performed a rotate operation on the page from Document 3 by rotating it 90-degrees.

From here, the user can add further pages to their composition document if they so desire. To do so, they would simply indicate that they wish to add an additional page to the composition document via page manipulation button 258. They can then continue to add to their composition document from the selected documents, or select different or additional documents from their personal imaging repository.

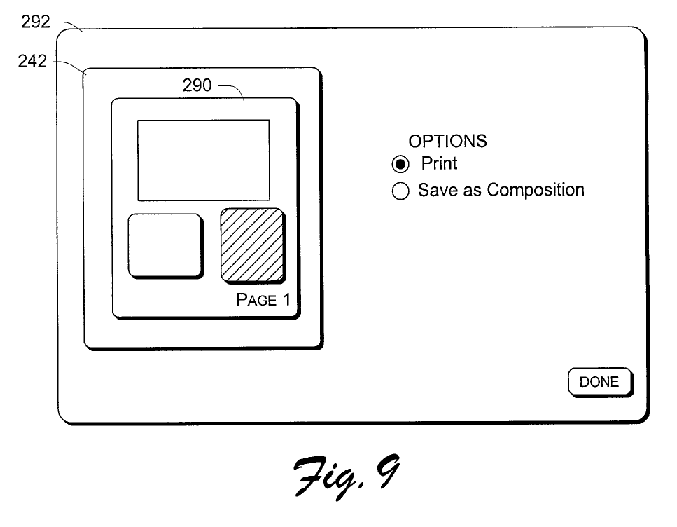

Once the user has completed their composition document, they can select a “Done” button (lower right hand corner of the user interface). Subsequently, as shown in FIG. 9, a user interface 292 can be presented to the user to give the user an option of printing their composition document, or saving the composition document to their personal imaging repository, or both.

Exemplary Document Assembly Module

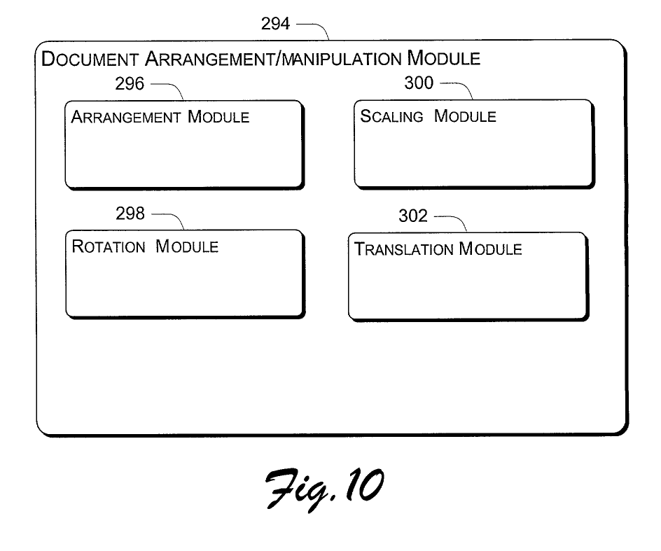

FIG. 10 shows an exemplary document arrangement/manipulation module 294 in accordance with one embodiment. The document arrangement/manipulation module can be implemented in any suitable hardware, software, firmware, or combination thereof. In the illustrated example, the document arrangement/manipulation module can be implemented in software.

In preferred embodiments, the document arrangement/manipulation module 294 is implemented as a network-based or Web-based service. Accordingly, such module can comprise a part of whatever system is providing such service. As an example, the document arrangement/manipulation module 294 can comprise part of content 228 of Web application 218 (FIG. 3), part of content 232 of service 220, part of content 212 of Web server 210, part of device content 238 of Web server 239, or part of device content 236 of Web server 237.

In this example, document arrangement/manipulation module 294 comprises functionality that enables a user to manipulate or otherwise arrange documents or pages in a composition document. Such functionality can include, without limitation:

an arrangement module 296 that accommodates physical arrangement of documents or pages within the composition document,

a rotation module 298 that accommodates rotation of documents or pages with the composition document,

a scaling module 300 that accommodates scaling of documents or pages with the composition document, and

a translation module 302 that accommodates translation of documents or pages with the composition document (i.e. translation with regard to the x- and y-coordinates on the composition document).

Any suitable techniques can be used to implement the various modules described above. Those of skill in the art of image-processing will understand and appreciate the different techniques that can be used to implement the various modules. Basic general image-processing techniques are described in a book entitled “Practical Algorithms for Image Analysis: Descriptions, Examples, and Code”, by Michael Seul, Lawrence O'Gorman, Michael J. Sammon (ISBN 0521660653). In addition, conventionally available software packages such as Visio 2000 utilize known techniques that permit arrangement, rotation, scaling, and translation. These and other known techniques can be utilized.

Exemplary Printing Process

Returning to FIG. 3, the process of printing a document in system 200 can be seen from the following example. Via the interface provided by Web browser 204 and content 208, the user is able to access images from different imaging sources, such as Web application 218, service 220, graphic store 216, or composition store 214. Additionally, as described above, the user is able, through the provided user interfaces, to build a composition document by selecting, arranging and manipulating various pages from one or more documents. The user can also select, if provided, one of a variety of pre-defined printer configurations stored in user profile store 234. Exemplary printer configurations are described in the U.S. patent application incorporated by reference above. In accordance with this incorporated disclosure, the user can select a printer on which to print the selected document, such as printer 225 coupled to proxy server 222, or printer 224. When the user selects the print option, an identification of the document, in this case the composition document (as well as an identification of the configuration, if selected) is communicated to the appropriate printer. Upon receipt of the print request, the printer prints the requested document, applying all of the requested print options in the configuration that it supports (e.g., functions that the printer offers (such as stapling) and that the printer is equipped to perform (such as being loaded with staples)).

The print request communicated to the printer includes an identifier of the document, in this case the composition document, that is to be printed. Any of a wide variety of identifiers can be used, such as a Uniform Resource Locator (URL). This may be an identifier of a single document (e.g., a document in graphic store 216), or an identifier of a composition document (e.g., a document in composition store 214) that itself includes identifiers of one or more other documents or pages from other documents. Alternatively, the data of the document to be printed may be communicated to the printer from the client 202, such as by the device content 236 of FIG. 3 (when downloaded and executed on the client 202). The data of the document may be communicated with the print request, or alternatively subsequent to the print request.

Exemplary Methods

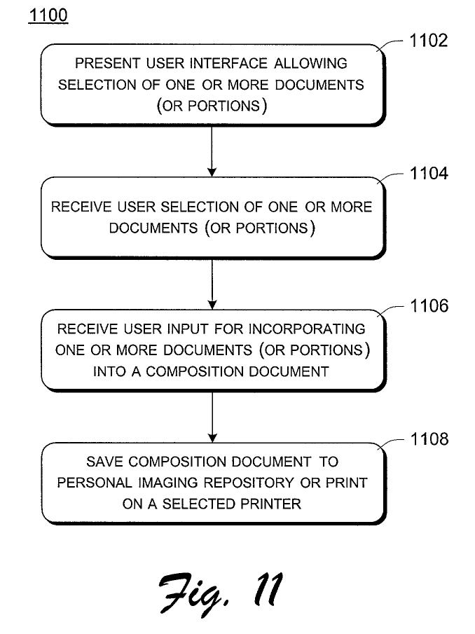

FIG. 11 is a flowchart illustrating an exemplary process 1100 for enabling a user to create a composition document. The process of FIG. 11 is desirably performed by the above-described network-based or Web-based service which, as described, can be embodied in content 208, content 228, content 232, content 212, device content 236 or device content 238.

Step 1102 presents a user interface that allows user selection of one or more documents or portions thereof. An exemplary user interface 266 for implementing this step is described in connection with FIG. 6. Step 1104 receives a user selection of one or more documents or portions thereof. An example of how this can be done is shown and described in connection with FIG. 6.

Step 1106 receives user input for incorporating one or more documents, or a portion thereof, into a composition document. An example of how this can be done is shown and described in connection with FIGS. 7 and 8. Having received the user input at step 1106, step 1108 saves the composition document to a personal imaging repository or prints the composition document on a selected printer. It is to be appreciated that step 1108 can be accomplished through the use of an identifier that is associated with the composition document, or through the use of data comprising the composition document itself. Specific examples of identifiers are discussed above.

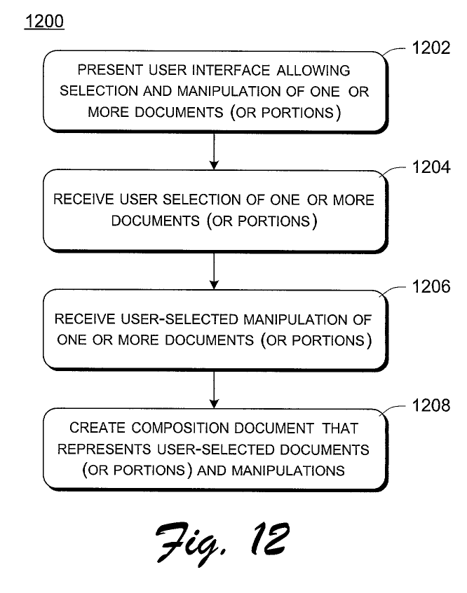

FIG. 12 is a flowchart illustrating an exemplary process 1200 for enabling a user to create and manipulate a composition document. The process of FIG. 12 is desirably performed by the above-described network-based or Web-based service which can be embodied in content 208, content 228, content 232, content 212, device content 236 or device content 238.

Step 1202 presents a user interface allowing selection and manipulation of one or more documents (or portions thereof). An exemplary interface for allowing selection of the documents is shown in FIG. 6. Exemplary interfaces for allowing manipulation of the documents are shown in FIGS. 7 and 8. The manipulations of the documents or document portions can be any suitable manipulations. As but examples, manipulations can include where a particular document is placed or assembled relative to a composition document page, and a state in which it is placed there. Specifically, with respect to a document's state, various embodiments enable a user to manipulate a document or document portion by rotating, scaling, translating and/or various combinations of these and other manipulations.

Step 1204 receives user selection of one or more documents. An example of how this can be done is described in FIG. 6. Step 1206 receives user-selected manipulation of one or more documents. An example of how this can be done is shown and described in connection with FIGS. 7 and 8. It is to be appreciated and understood that user-selected manipulation of a document or document portion can comprise manipulations that are performed on the document or document portion itself, or instructions or other data that instruct the manipulations to be performed at some later date.

Step 1208 creates a composition document that represents the user-selected documents (or portions) and manipulations. This step can be implemented by creating an actual composition document, or by creating a set document with data such as links and instructions which, when executed, create an actual composition document that can be printed, or combinations of both. The user-selected manipulations can be implemented using a software module such as module 294 in FIG. 10. This module, or various portions of the module, can be embodied as content that is accessible via the Web service.

Various acts are illustrated in the processes of FIGS. 11 and 12 above. However, no particular required order is to be associated with the acts based on their order of presentation in FIGS. 11 and 12. The acts may be performed in different orders than they are presented in FIGS. 11 and 12, and multiple acts may be performed concurrently (or partly concurrently).

Example Implementation

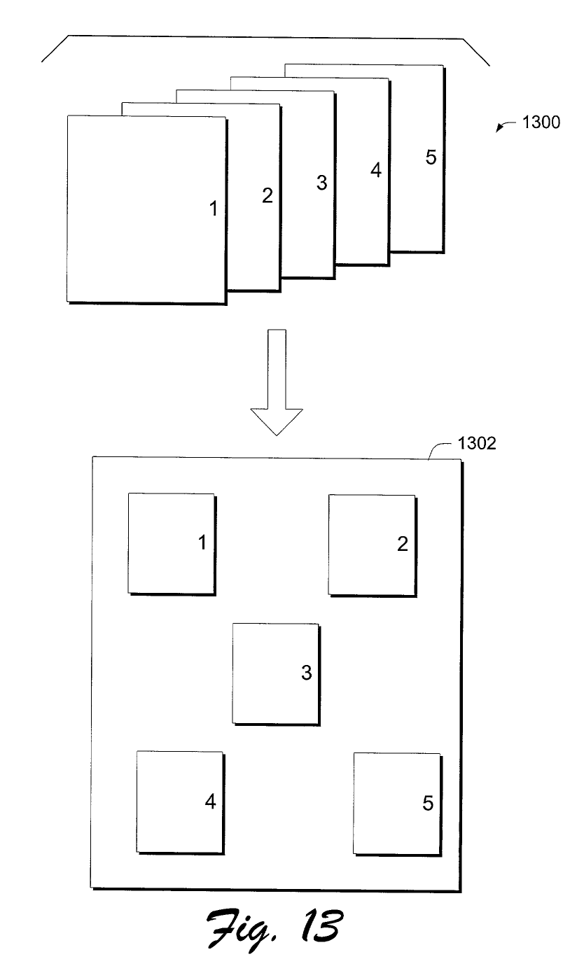

As an example of how the above-described embodiments can be used to enable a user to manipulate and arrange documents, consider the following in connection with FIG. 13.

Consider a user who has, in their personal imaging repository, a Microsoft Word document having five pages. The user wishes to lay all of the pages out on a single page for printing. In the FIG. 13 example, the user's Word document is shown at 1300. Using the above described Web service, the user can create a composition page 1302 in which all of the pages of document 1300 are arranged on a single page for printing. The pages of document 1300 can be scaled down so that they fit on composition page 1302.

Consider additionally FIG. 13 in the context of this new example. Assume that instead of a Word document having five pages, each page of collection 1300 constitutes image data that provides a photographic image of a favorite family member. Perhaps the collection 1300 is taken from a single composition document in the user's personal imaging repository, or, perhaps the individual pages come from different files stored in the repository. Assume also that the paper on which the image data it to be printed is expensive, e.g. glossy paper upon which photographs can typically be printed. Now, instead of having to print the individual pages of collection 1300 on five separate glossy pages, the user can, using the above-described Web service, arrange the individual logical pages of collection 1300 (and perhaps scale them down) onto a representation of a physical page that is to be printed (i.e. page 1302). Now, when the user prints the image data, only one glossy page is required. This can constitute a desirable cost savings for the user.

Some Server Side Issues

Although the inventive embodiments have been described largely in the context of the client side environment, it is to be appreciated and understood that various aspects of the described embodiments can be implemented on the server side. As an example, consider the following. The above-described imaging extension is used to make user information available to content downloaded into the user's browser. In other words, the imaging extension makes information associated with the user's identity available. Thus, one purpose of the imaging extension is to provide access to the user's personal imaging repository.

As was mentioned, this can be accomplished through the imaging extension which extends the behavior of the browser. Although there are advantages to this approach, there are also disadvantages-namely, the browser must somehow be extended. Although it is possible to extend browsers on Windows operating systems, it becomes harder to do this for newer devices like PDAs. Consequently, it is desirable to support the notion of identity without requiring the browser to be extended.

Supporting identity without requiring the browser to be extended can be accomplished by moving the logic normally present in the web content running within the browser into the web server. That is, rather than the web content accessing the user's personal imaging repository, the web server accesses the user's personal imaging repository. In other words, the identity technology is on the server side instead of client side.

One of the problems that arises in this context pertains to the server being able to determine the location of the user's personal imaging repository (more specifically, the user profile which can act as the root of the personal imaging repository). In the client side identity approach, the imaging extension running within the browser implicitly addressed this issue. The content, by virtue of the fact that it is running within the user's browser and accessing the imaging extension, “knows” the identity of the user. For the server, a different approach can be employed since the browser no longer typically provides any sort of hint regarding the user's identity. One approach to solving this problem is to use an authentication website. The website in question can redirect to the authentication website which then determines the identity of the user, and then redirects back to the user with the user identity, including the location of the user's profile. In this scheme, it is assumed that all websites “know” about the authentication server.

Once the user's identity is determined (i.e. the location of the user's profile is know) the website can directly interact with services in the user's personal imaging repository without the aid of the imaging extension. It is also possible to add security to this model. Such could be done using known techniques.

Exemplary Computer System

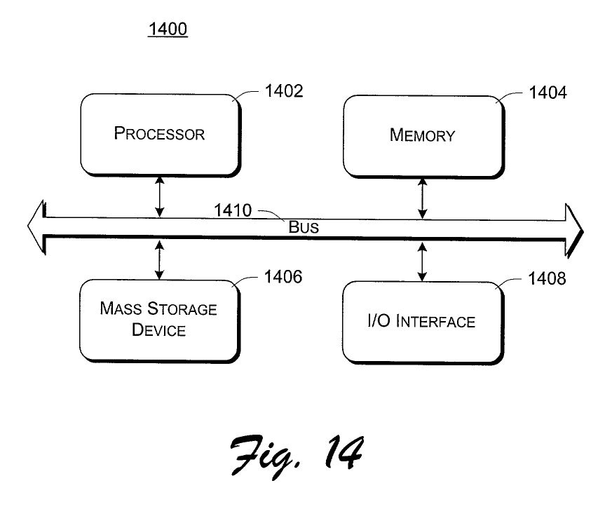

FIG. 14 illustrates an exemplary computer system 1400 in additional detail. Computer system 1400 can be, for example, a network client 102 of FIG. 1, an imaging client 152 or server 154 or 156 of FIG. 2, an imaging client 202, server 210 or 222 of FIG. 3, etc. Computer system 1400 represents a wide variety of computing devices, such as desktop computers, portable computers, dedicated server computers, multi-processor computing devices, cellular telephones, personal digital assistants (PDAs), handheld or pen-based computers, microcontroller-based electronic devices, gaming consoles, and so forth.

Computer system 1400 includes one or more processors 1402, memory 1404, a mass storage device 1406, and an input/output (I/O) interface 1408, all coupled to a bus 1410. Bus 1410 represents one or more buses in computer system 1400, such as a system bus, processor bus, accelerated graphics port (AGP), peripheral component interconnect (PCI), and so forth. The bus architecture can vary by computing device as well as by manufacturer. I/O interface 1408 is a conventional interface allowing components of system 1400 (e.g., processor(s) 1402) to communicate with other computing devices via a network, such as network 158 of FIG. 2. I/O interface 1408 may be, for example, a modem, a network interface card (NIC), and so forth.

Memory 1404 represents volatile and/or nonvolatile memory used to store instructions and data for use by processor 1402. Typically, instructions are stored on a mass storage device 1406 (or nonvolatile memory) and loaded into a volatile memory 1404 for execution by processor(s) 1402. Additional memory components may also be involved, such as cache memories internal or external to processor 1402. Various embodiments can be implemented, at different times, in any of a variety of computer readable media that is part of, or readable by, system 1400. For example, such computer readable media may be mass storage device 1406, memory 1404 or a cache memory, a removable disk (not shown) that is accessible by processor 1402 or another controller of system 1400 (such as a magnet disk or optical disk), and so forth.

Computer system 1400 is exemplary only. It is to be appreciated that additional components (not shown) can be included in system 1400 and some components illustrated in system 1400 need not be included. For example, a display adapter, additional processors or storage devices, additional I/O interfaces, and so forth may be included in system 1400, or mass storage device 1406 may not be included.

I/O interface 1408 is a conventional interface allowing components of system 1400 (e.g., processor 1402) to communicate with other computing devices via a network, such as network 158 of FIG. 2.

The discussions herein refer primarily to software components and modules that can be executed by a computing device. It is to be appreciated, however, that the components and processes described herein can be implemented in software, firmware, hardware, or a combination thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
causing, via at least one network service, a user interface to be presented on a client device, the user interface being configured to enable a user to select imaging data from a personal imaging repository;
receiving, via said at least one network service, a user selection of imaging data from the personal imaging repository;
receiving, via said at least one network service, user input for incorporating the imaging data into a composition document; and
saving, via said at least one network service, the composition document in the personal imaging repository.

2. The method of claim 1, wherein said receiving user input comprises receiving user input that causes the imaging data to be arranged on the composition document.

3. The method of claim 1, wherein said receiving user input comprises receiving user input that causes the imaging data to be manipulated on the composition document.

4. The method of claim 1, wherein said receiving user input comprises receiving user input that causes the imaging data to be manipulated on the composition document by causing at least a portion of the imaging data to appear rotated on the composition document when the composition document is printed.

5. The method of claim 1, wherein said receiving user input comprises receiving user input that causes the imaging data to be manipulated on the composition document by causing at least a portion of the imaging data to appear scaled on the composition document when the composition document is printed.

6. The method of claim 1, wherein said receiving user input comprises receiving user input that causes the imaging data to be manipulated on the composition document by causing at least a portion of the imaging data to appear translated on the composition document when the composition document is printed.

7. The method of claim 1, wherein said receiving user input comprises receiving user input that causes the imaging data to be manipulated on the composition document by causing at least a portion of the imaging data to be presented on a printed composition document in a state that is different from a state in which the imaging data would have been presented on a printed page were the imaging data to have been printed prior to said receiving user input for incorporating the imaging data into the composition document.

8. The method of claim 1, wherein said acts of causing, receiving user selection, receiving user input and saving are performed by multiple network services.

9. The method of claim 1, wherein said at least one network service is implemented, at least in part, by at least one printer.

10. The method of claim 1, wherein said at least one network service is implemented, at least in part, by at least one proxy server that serves as a proxy for at least one printer.

11. One or more computer-readable media having stored thereon computer-readable instructions which, when executed by one or more processors, cause the processors to:
send content to a client device, said content enabling the client device to:
display a user interface that is configured to enable a user to select imaging data from a personal imaging repository;
provide, over a network, a user selection of imaging data from the personal imaging repository;
provide, over the network, user input for incorporating the imaging data into a composition document.

12. One or more computer-readable media as recited in claim 11, wherein the instructions further cause the one or more processors to save, via the network, the composition document in the personal imaging repository.

13. One or more computer-readable media as recited in claim 11, wherein the instructions further cause the one or more processors to print, via the network, the composition document on one or more network accessible printers.

14. One or more computer-readable media as recited in claim 11, wherein the instructions further cause the one or more processors to provide said user selection and said user input over a network comprising the Internet.

15. A method comprising:
causing, via at least one Web service, a user interface to be presented on a client device, the user interface being configured to enable a user to select imaging data from a Web-accessible personal imaging repository;
receiving, via said at least one Web service, a user selection of imaging data from the personal imaging repository;
receiving, via said at least one Web service, user input for incorporating the imaging data into a composition document; and
saving, via said at least one Web service, the composition document in the personal imaging repository.

16. The method of claim 15, wherein said receiving user input comprises receiving user input that causes the imaging data to be arranged on the composition document.

17. The method of claim 15, wherein said receiving user input comprises receiving user input that causes the imaging data to be manipulated on the composition document by causing at least a portion of the imaging data to appear at least one of the following, when the composition document is printed: (1) rotated, (2) scaled, and (3) translated.

18. The method of claim 15, wherein said receiving user input comprises receiving user input that causes the imaging data to be manipulated on the composition document by causing at least a portion of the imaging data to be presented on a printed composition document in a state that is different from a state in which the imaging data would have been presented on a printed page were the imaging data to have been printed prior to said receiving user input for incorporating the imaging data into the composition document.

19. A method comprising:
causing, via at least one network service, a user interface to be presented on a client device, the user interface being configured to enable a user to select imaging data from a personal imaging repository;
receiving, via said at least one network service, a user selection of imaging data from the personal imaging repository;
receiving, via said at least one network service, user input for incorporating the imaging data into a composition document, said user input causing one or more of (1) the imaging data to be arranged on the composition document, and (2) the imaging data to be manipulated on the composition document; and
printing, via said at least one network service, the composition document on one or more network-accessible printers.

20. The method of claim 19, wherein at least one of said at least one network services is implemented, at least in part, by at least one printer.

21. The method of claim 19, wherein said receiving user input that causes the imaging data to be manipulated on the composition document comprises receiving user input that causes at least a portion of the imaging data to appear rotated on the composition document when the composition document is printed.

22. The method of claim 19, wherein said receiving user input that causes the imaging data to be manipulated on the composition document comprises receiving user input that causes at least a portion of the imaging data to appear scaled on the composition document when the composition document is printed.

23. The method of claim 19, wherein said receiving user input that causes the imaging data to be manipulated on the composition document comprises receiving user input that causes at least a portion of the imaging data to appear translated on the composition document when the composition document is printed.

24. The method of claim 19, wherein said receiving user input that causes the imaging data to be manipulated on the composition document comprises receiving user input that causes at least a portion of the imaging data to appear at least one of (1) rotated, (2) scaled, and (3) translated on the composition document when the composition document is printed.

25. A graphical user interface comprising:
a document arrangement portion configured to enable a user to select one or more documents from a Web-accessible personal imaging repository;
a document preview window configured to enable a user to view iconic representations of one or more pages of the one or more documents; and
a selected documents portion that enables a user to view iconic representations of the one or more documents.

26. The graphical user interface of claim 25 further comprising a preview portion configured to enable a user to toggle the document preview window between a representation of a physical page that the user is creating and one or more other pages that the user is using to create the physical page.

27. The graphical user interface of claim 25 further comprising means for presenting one or more manipulation operations that can be selected by a user for application to one or more of the selected documents.

28. The graphical user interface of claim 25 further comprising means for presenting one or more manipulation operations that can be selected by a user for application to one or more of the selected documents, said manipulation operations comprising one or more of (1) a rotation operation, (2) a scaling operation, and (3) a translation operation.

29. A web service comprising:
means for enabling a user to access one or more documents from a Web-accessible personal imaging repository that is associated with the user;
means for enabling the user to arrange one or more documents or portions thereof to define a composition document; and
means for enabling the user to manipulate portions of the composition document.

30. The web service of claim 29 further comprising means for saving the composition document.

31. The web service of claim 29 further comprising means for saving the composition document in the personal imaging repository.

32. The web service of claim 29 further comprising means for printing the composition document.

33. The web service of claim 29 further comprising means for printing the composition document on one or more Web-accessible printers.
